(19) United States
(12) Patent Application Publication
(10) Pub. No.: US 2025/0333868 A1
(43) Pub. Date: Oct. 30, 2025

(54) Separator for Water Electrolysis

(71) Applicant: Agfa-Gevaert NV, Mortsel (BE)

(72) Inventor: Willem Mues, Mortsel (BE)

(73) Assignee: Agfa-Gevaert NV, Mortsel (BE)

(21) Appl. No.: 18/869,979

(22) PCT Filed: May 23, 2023
(86) PCT No.: PCT/EP2023/063760

§ 371 Date: Nov. 27, 2024

(30) Foreign Application Priority Data
May 30, 2022 (EP) 22176060.6

(51) Int. Cl. C25B 13/04; C25B 13/02

(52) U.S. Cl. CPC C25B 13/04; C25B 13/02

(57) ABSTRACT

A separator (1) for water electrolysis comprising on at least one side thereof:—a surface area Sₘₐₓ,—a surface area Sc for contacting a surface of an electrode, and—a channel (10) for evacuating gas bubbles having a cross section Φ_{c}, characterized in that:—a ratio S_{c}/Sₘₐₓ is from 0.025 to 0.50, and—the cross section Φ_{c} is large enough for evacuating gas bubbles having a diameter from 5 to 50 μm.

### TECHNICAL FIELD OF THE INVENTION

The present invention relates to separators for water electrolysis and to electrolytic cells including such separators.

### BACKGROUND ART FOR THE INVENTION

Nowadays, hydrogen is used in several industrial processes, for example its use as raw material in the chemical industry and as a reducing agent in the metallurgic industry. Hydrogen is a fundamental building block for the manufacture of ammonia, and hence fertilizers, and of methanol, used in the manufacture of many polymers. Refineries, where hydrogen is used for the processing of intermediate oil products, are another area of use. However, the production of hydrogen from fossil fuels results in massive CO₂ emission.

Hydrogen is also being considered an important future energy carrier, which means it can store and deliver energy in a usable form. Energy is released by an exothermic combustion reaction with oxygen thereby forming water. During such combustion reaction no greenhouse gases containing carbon are emitted.

For the realization of a low-carbon society, renewable energies using natural energy such as solar light and wind power are becoming more and more important.

The production of electricity from wind power and solar power generation systems is very much dependent on the weather conditions and therefore variable, leading to an imbalance of demand and supply of electricity. To store surplus electricity, the so-called power-to-gas technology wherein electrical power is used to produce gaseous fuel such as hydrogen, attracted much interest in recent years. As production of electricity from renewable energy sources will increase, the demand for storage and transportation of the produced energy will also increase.

Water electrolysis is an important manufacturing process wherein renewable electricity may be converted into hydrogen. Hydrogen produced in this way is often referred to as green hydrogen, emphasizing that no greenhouse gases are formed during its production. Ammonia and steel prepared from or with green hydrogen are also referred to as green ammonia and green steel.

In an alkaline water electrolyser, a so-called separator or diaphragm is used to separate electrodes of different polarity to prevent a short circuit between these electrodes and to prevent the recombination of hydrogen (formed at the cathode) and oxygen (formed at the anode) by avoiding gas crossover. In addition, the separator should also be a highly ionic conductor for transportation of hydroxyl ions from the cathode to the anode.

In a so-called zero gap electrolytic cell the electrodes are placed directly in contact with the separator thereby reducing the distance between both electrodes. Mesh-type or porous electrodes are used to enable the separator to be filled with electrolyte and for efficient removal of the oxygen and hydrogen gases formed. It has been observed that such zero gap electrolytic cells may operate at higher current densities, thereby improving the efficiency of the electrolysis.

However, in such a zero gap electrolytic cell it has been observed that gas bubbles formed inside the separator may migrate towards the upper region of the electrolytic cell where they can accumulate. Such accumulation of gas bubbles may result in a higher ionic resistance in that part of the cell. A temperature rise as a result of a less efficient cooling by the electrolyte in that area of the electrolysis cell may even result in burning of the separator.

It has been observed that introducing a small distance between one side of the separator and at least one electrode results in less accumulation of gas bubbles inside the separator. A so-called spacer may be used to realise the distance between the separator and the electrode.

However, introducing such a spacer between the separator and the electrode(s) increases the complexity and the cost of a zero gap electrolytic cell and may moreover negatively influence its ionic conductivity resulting in a less efficient electrolysis process.

There is thus a need for a zero gap electrolytic cell having an improved hydrogen forming efficiency and for a separator to be used therein.

### SUMMARY OF THE INVENTION

It is an object of the invention to provide a separator for a more efficient zero gap electrolytic cell.

This object is realized with the separator as defined in claim 1.

Further objects of the invention will become apparent from the description hereinafter.

### BRIEF DESCRIPTION OF THE DRAWINGS

FIG. 1 schematically depicts an embodiment of a separator according to the present invention.

FIG. 2 schematically depicts different channel patterns of separators according to the present invention.

FIG. 3 schematically depicts an embodiment of a separator according to the present invention.

FIG. 4 schematically depicts another embodiment of a separator according to the present invention.

FIG. 5 schematically depicts a top view of an embodiment of a zero-gap Electrode Membrane Assembly according to the present invention.

FIG. 6 schematically depicts an embodiment of a manufacturing method for a separator according to the present invention.

### DETAILED DESCRIPTION OF THE INVENTION Separator

A separator (1) for water electrolysis according to the present invention has on at least one side:
a surface area Sₘₐₓ,
a surface area S_{c} for contacting a surface of an electrode, and
a channel (10) having a cross section Φ_{c} for evacuating gas bubbles, characterized in that:
a ratio S_{c}/Sₘₐₓ is from 0.025 to 0.50, and
the cross section Φ_{c} is large enough for evacuating gas bubbles having a diameter from 5 to 50 μm.

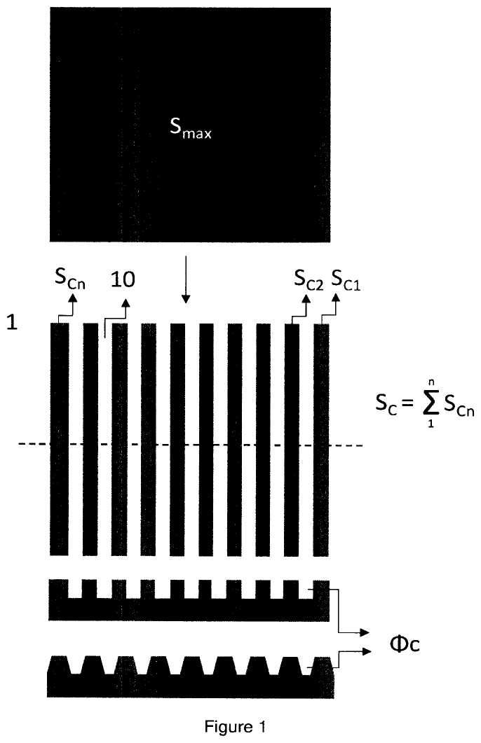

The surface area Sₘₐₓ on a side of the separator corresponds to the surface area of a side of the separator before the channels (10) are incorporated into that side of the separator, as illustrated in FIG. 1.

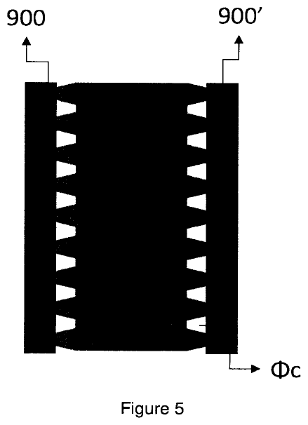

The surface area S_{c} of a side of the separarot is the total surface are of the separator that may contact an electrode (900, 900′) when placed into a zero gap electrolytic cell as shown in FIG. 5 (Top view of a zero gap Membrane Electrode Assembly (MEA).

The total surface area S_{c} (of one side of the separator) is calculated according to the following Formula (I):

$${S}_{C} = {\sum }_{1}^{n} {S}_{Cn} \qquad Formula ( I )$$

The separator comprises on at least one side of the separator at least one channel. Such a channel may also be referred to as a groove or a path. Such a channel is capable of evacuating gas bubbles formed in such a channel upwards towards the upper region of the electrolytic cell.

The channels of the separator referred to above have to be differentiated from pores of the separator described below. Pores in a separator according to the present invention allows the passage of electrolyte through the separator. The diameters of these pores are optimized to prevent gasses such as hydrogen or oxygen to pass through the separator. The channels of a separator according to the present invention allows the gas bubbles formed to be evacuated upwards (i.e. alongside the separator surface) towards the upper region of the electrolytic cell.

Gas bubbles formed in the vicinity of the electrode, due to supersaturated electrolyte, may now be evacuated through the channels of the separator instead of gas bubbles being formed inside the separator in case such channels would not be present.

The cross section of the channels Φ_{c} may be large enough to enable gas bubble formation and gas bubble evacuation. Gas bubbles typically have a diameter from 5 to 50 μm.

The ratio S_{c}/Sₘₐₓ is from 0.025 to 0.50, preferably from 0.05 to 0.4, more preferably from 0.1 to 0.3. When the ratio is more than 0.5 gas bubbles may be formed inside the separator resulting in a less efficient electrolysis. When the ratio is less than 0.025, the physical strength of the separator may be become too low.

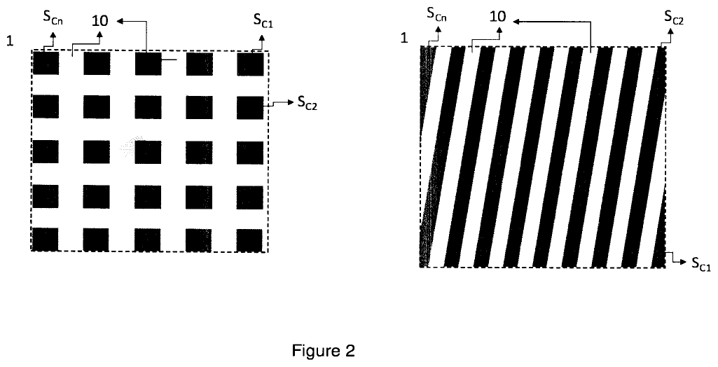

The channels of the separator may have different shapes, sizes and orientations as shown in FIGS. 1 and 2, as long as they are able to evacuate gas bubbles towards the upper region of the electrolytic cell.

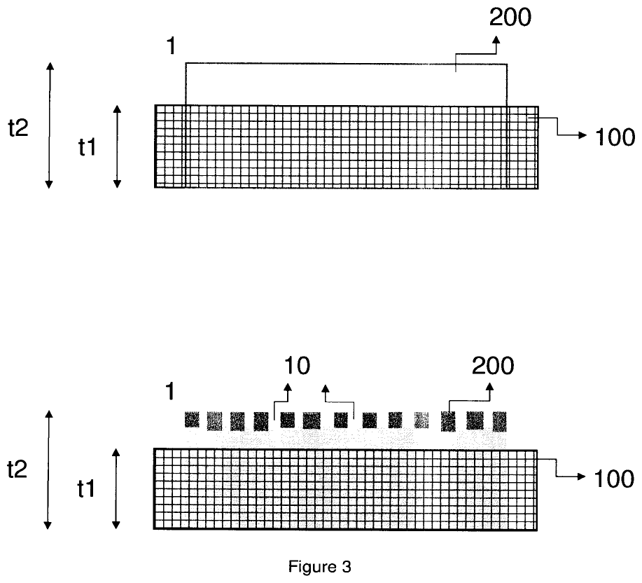

A separator according to one embodiment of the present invention includes channels on at least one side of the separator (see FIG. 3).

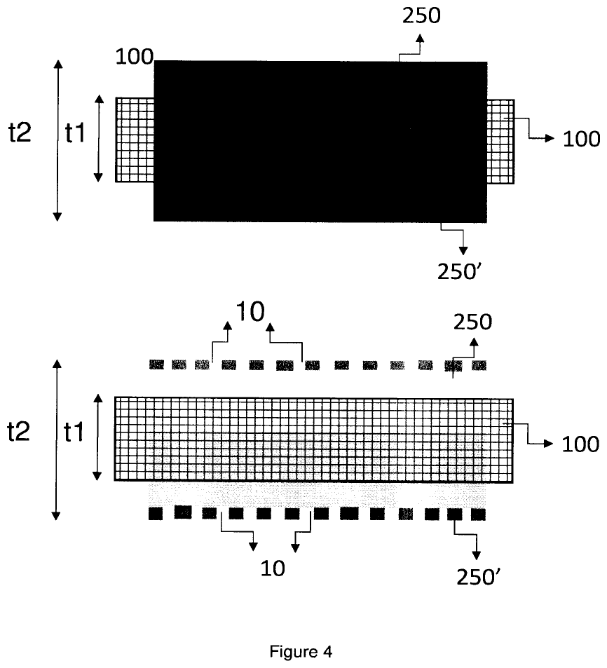

A separator according to another more preferred embodiment has channels on both sides of the separator (FIG. 4). The channels on one side of the separator may be different than the channels on the other side. However, a preferred separator has the same channels on both sides.

A preferred separator for alkaline water electrolysis comprises a porous layer (200) provided on an porous support (100) as schematically shown in FIG. 3.

A particular preferred separator comprises a first porous layer (250) provided on one side of a porous support (100) and a second porous layer (250′) provided on the other side of the porous support (see FIG. 4). The first (250) and second (250′) porous layers may be identical or different from each other.

The channels referred to above are preferably prepared in these porous layers, as described below.

The porous layer preferably comprise a polymer and inorganic particles both as described below.

The thickness of the separator (t2) is preferably from 50 to 750 μm, more preferably from 75 to 500 μm, most preferably from 100 to 250 μm, particularly preferred from 125 to 200 μm. Increasing the thickness of the separator typically results in a higher physical strength of the separator. However, increasing the thickness of the separator may also result in a decrease of the electrolysis efficiency due to an increase of the ionic resistance.

The separator prevents mixing of hydrogen and oxygen formed at respectively the cathode and the anode. Therefore, the separator preferably has a maximum pore diameter (PDmax) measured with the Bubble Point Test method from 0.05 to 2 μm, more preferably from 0.10 to 1 μm, most preferably from 0.15 to 0.5 μm. The Bubble Point Test method is described in American Society for Testing and Materials Standard (ASMT) Method F316. This technique is based on the displacement of a wetting liquid embedded in the separator by applying an inert pressurised gas.

The Bubble Point Test method may be adapted to measure a maximum pore diameter (PDmax) on both sides of a separator by using a grid supporting one side of the separator during the measurement. Another measurement is then carried out using the grid supporting to other side of the separator. Measuring PDmax on both sides of a separator is preferably carried out on separators having a porous layer on both sides of a porous support.

The PDmax measured for both sides of the separator may be substantially identical or different from each other.

Separators having a similar PDmax on both sides have the advantage that a defect, for example a scratch, on one side of the separator does not immediately result in a higher gas permeation through the separator because there are still small pores on the other side of the separator.

The separator includes pores having a sufficiently small pore diameter to prevent recombination of hydrogen and oxygen by avoiding gas crossover in the longitudinal direction of the separator. On the other hand, to ensure efficient transportation of hydroxyl ions from the cathode to the anode the pore diameter may not be too small to ensure an efficient penetration of electrolyte into the separator. Separators having a different PDmax on both sides may have a better compromise between efficient gas separation and ionic conductivity. Such separators may have a PDmax (1) of a first porous layer of preferably from 0.05 to 0.3 μm, more preferably from 0.08 to 0.25 μm, most preferably from 0.1 to 0.2 μm and a PDmax (2) of a second porous layer of preferably from 0.1 to 6.5 μm, more preferably from 0.15 to 1.50 μm, most preferably from 0.2 to 0.5 μm. The ratio PDmax (2)/PDmax (1) is preferably from 1.1 to 20, more preferably from 1.25 to 10, most preferably from 2 to 7.5. The smaller PDmax (1) ensure an efficient separation of hydrogen and oxygen while PDmax (2) ensures a good penetration of the electrolyte in the separator resulting in a sufficient ionic conductivity.

The separator preferably has an ionic resistance at 80° C. in a 30 wt % aqueous KOH solution of 0.1 ohm.cm² or less, more preferably of 0.07 ohm.cm² or less. The ionic resistance may be determined with an Inolab® Multi 9310 IDS apparatus available from VWR, part of Avantor, equipped with a TetraCon 925 conductivity cell available from Xylem.

The porosity of the separator is preferably from 30 to 70%, more preferably from 40 to 60%. A separator having a porosity within the above ranges typically has excellent ion permeability and excellent gas barrier properties because the pores of the diaphragm are continuously filled with an electrolyte solution. A porosity of 80% or higher would result in a too low mechanical strength of the separator and a too high permeation of electrolyte, the latter resulting in an increase of the HTO (wt % hydrogen present in the oxygen formed at the anode).

The gas permeability of the membrane is preferably between 1 and 7 L/min.cm², more preferably between 1.5 and 6.5 L/min.cm², most preferably between 2 and 5.5 L/min.cm².

### Porous Support

The porous support may be used to reinforce the separator to ensure its mechanical strength.

A thickness of the porous support (t1) is preferably 350 μm or less, more preferably 200 μm or less, most preferably 100 μm or less, particularly preferred 75 μm or less.

It has been observed that the ion conductivity through a reinforced separator increases when the thickness of the porous support decreases.

However, to ensure sufficient mechanical properties of the reinforced separator, the thickness of the porous support is preferably 20 μm or more, more preferably 40 μm or more.

The porous support may be selected from the group consisting of a porous fabric and a porous ceramic plate.

The porous support is preferably a non-woven fabric, a woven fabric, a mesh or a felt, more preferably a non-woven or woven fabric.

The porous support is preferably a porous fabric, more preferably a porous polymer fabric.

The porous polymer fabric may be woven or non-woven. Woven fabrics typically have a better dimensional stability and homogeneity of open area and thickness. However, the manufacture of woven fabrics with a thickness of 100 μm or less is more complex resulting in more expensive fabrics. The manufacture of non-woven fabrics is less complex, even for fabrics having a thickness of 100 μm or less. Also, non-woven fabrics may have a larger open area.

The open area of the porous support is preferably between 30 and 80%, more preferably between 40 and 70%, to ensure a good penetration of the electrolyte into the support.

The fabric preferably has a fibre diameter from 20 μm to 200 μm, more preferably from 40 μm to 150 μm, most preferably from 60 μm to 100 μm. Fabrics having a lower thickness preferably have a smaller fibre diameter. For example a fabric having a thickness t1 of 150 μm or lower preferably has a fibre diameter of 75 μm or lower, more preferably of 50 μm or lower, most preferably of 35 μm or lower.

To further reduce the thickness t1 of the fabric, the ratio of the gauze thickness to the fibre diameter is preferably less than 2.0, more preferably 1.7 or less, most preferably 1.4 or less. A thinner fabric makes it possible to prepare thinner separators.

Suitable porous polymer fabrics are prepared from polypropylene (PP), polyethylene (PE), polysulfone (PSU), polyphenylene sulfide (PPS), polyamide/nylon (PA), polyether sulfone (PES), polyphenyl sulfone (PPSU), polyethylene terephthalate (PET), polyether-ether ketone (PEEK), sulfonated polyether-ether keton (s-PEEK), monochlorotrifluoroethylene (CTFE), copolymers of ethylene with tetrafluorethylene (ETFE) or chlorotrifluorethylene (ECTFE), polyimide, polyether imide and m-aramide.

A preferred polymer fabric is prepared from polypropylene (PP), polyether ether ketone (PEEK) or polyphenylene sulfide (PPS), most preferably from polyether ether ketone (PEEK) or polyphenylene sulfide (PPS).

A PPS or PEEK-based porous support has a high resistance to high-temperature, high concentration alkaline solutions and a high chemical stability against active oxygen evolved from an anode during the water electrolysis process. Also, PPS and PEEK can be easily processed into various forms such as a woven fabric or a non-woven fabric.

The density of the porous support is preferably between 0.1 to 0.7 g/cm³.

The porous support is preferably a continuous web to enable a manufacturing process as disclosed in EP-A 1776490 and WO2009/147084.

The width of the web is preferably between 30 and 300 cm, more preferably between 40 and 200 cm.

### Polymer

The porous layer comprises a polymer.

The polymer forms a three dimensional porous network, the result of a phase inversion step in the preparation of the separator, as described below.

The polymer resin may be selected from a fluorine resin such as polyvinylidene fluoride (PVDF) and polytetrafluoroethylene (PTFE), an olefin resin such as polypropylene (PP), and an aromatic hydrocarbon resin such as polyethylene terephthalate (PET) and polystyrene (PS). The polymer resins may be used alone, or two or more of the polymer resins may be used in combination.

PVDF and vinylidenefluoride (VDF)-copolymers are preferred for their oxidation/reduction resistance and film-forming properties. Among these, terpolymers of VDF, hexanefluoropropylene (HFP) and chlorotrifluoroethylene (CTFE) are preferred for their excellent swelling properties, heat resistance and adhesion to electrodes.

Another preferred polymer is an aromatic hydrocarbon polymer for their excellent heat and alkali resistance. Examples of an aromatic hydrocarbon polymers include polyethylene terephthalate, polybutylene terephthalate, polybutylene naphthalate, polystyrene, polysulfone, polyethersulfone, polyphenylene sulfide, polyphenyl sulfone, polyacrylate, polyetherimide, polyimide, and polyamide-imide.

A particular preferred polymer resin is selected from the group consisting of polysulfone, polyethersulfone, polyphenylene sulfide, polyether ether ketone and polyphenylsulfone, polysulfone being the most preferred.

The molecular weight (Mw) of the polymer is preferably between 10 000 and 500 000, more preferably between 25 000 and 250 000. When the Mw is too low, the physical strength of the porous layer may become insufficient. When the Mw is too high, the viscosity of the dope solution (see below) may become too high. Examples of polysulfones, polyether sulfones and combinations thereof are disclosed in EP-A 3085815, paragraphs to

The amount of polymer is preferably from 5 to 40 wt %, more preferably from 10 to 30 wt %, most preferably from 15 to 25 wt %, all relative to the total dry weight of the porous layer.

### Inorganic Particles

The porous layer preferably comprises inorganic particles. The inorganic particles render the porous layer hydrophilic. The hydrophilic nature of the porous layer prevents the adhesion of hydrogen and oxygen bubbles to the separator surface. Such adhesion of gas bubbles would reduce the electrolysis efficiency.

Preferred inorganic particles are selected from metal oxides and metal hydroxides.

Preferred metal oxides are selected from the group consisting of zirconium oxide, titanium oxide, bismuth oxide, cerium oxide and magnesium oxide.

Preferred metal hydroxides are selected from the group consisting of zirconium hydroxide, titanium hydroxide, bismuth hydroxide, cerium hydroxide and magnesium hydroxide. A particularly preferred magnesium hydroxide is disclosed in EP-A 3660188, paragraphs to [0063].

Other preferred inorganic particles are sulfates of calcium, barium, lead or strontium, barium sulfate particles being more preferred.

Still other inorganic particles that may be used are nitrides and carbides of Group IV elements of the periodic table.

A combination of one or more different inorganic particles may be used.

The inorganic particles may be natural substances or synthetic substances.

The surface of the inorganic particles may be untreated or may be surface-treated with for example a silane coupling agent, stearic acid, oleic acid, or a phosphoric acid ester.

The shape of the inorganic particles is not particularly limited as long as it is in the form of particles and may be any of irregular shapes, spherical shapes such as true spherical shapes and oblong spherical shapes, plate shapes such as flake shapes and hexagonal plate shapes, and fibrous shapes.

The inorganic particles preferably have a D₅₀ particle size from 0.05 to 2.0 μm, more preferably from 0.1 to 1.5 μm, most preferably from 0.15 to 1.00 μm, particularly preferred from 0.2 to 0.75 μm. The D₅₀ particle size is preferably 0.7 μm or less, more preferably 0.55 μm or less, most preferably 0.40 μm or less.

The D₅₀ particle size is also known as the median diameter or the medium value of the particle size distribution. It is the value of the particle diameter at 50% in the cumulative distribution. For example, if D₅₀=1.0 μm, then 50% of the particles are larger than 1.0 μm and 50% are smaller than 1.0 μm.

The D₅₀ particle size is preferably measured using laser diffraction, for example using a Mastersizer from Malvern Panalytical.

The amount of inorganic particles is preferably from 30 to 95 wt %, more preferably from 50 to 92 wt %, most preferably from 60 to 90 wt %, all relative to the total dry weight of the porous layer. The amount of inorganic particles is preferably at least 65 wt %, more preferably at least 75 wt %, all relative to the total dry weight of the porous layer.

The weight ratio of hydrophilic particles to polymer resin is preferably 60/40 or more, more preferably 70/30 or more, most preferably 75/25 or more.

### Preparation of the Separator

The preparation of a separator according to the present invention includes a a step wherein channels for evacuating gas bubbles are provided on at least one side of the separator.

For porous separators for alkaline water electrolysis, a preferred preparation method comprises the steps of:
applying a dope solution as described below on a side of a porous support (100);
performing phase inversion on the applied dope solution thereby forming a separator (1) comprising a porous layer (200) on the support; and
providing channels (60) into the porous layer (200) during the phase inversion step.

The channels are preferably provided in an early stage of the phase inventions step.

A dope solution may be applied on both sides of a porous support (100) thereby obtaining a separator (1) comprising a first and a second porous layer (250, 250′) on respectively one and the other side of the porous support. In this case, channels are provided into at least one porous layer, preferably into both porous layers.

The step of providing channels into the porous layer of a separator are preferably incorporated in the methods of manufacturing a reinforced separator disclosed in EP-A 1776490 and WO2009/147084 for symmetric separators and EP-A 3652362 for asymmetric separators. These methods result in web-reinforced separators wherein the web, i.e. the porous support, is nicely embedded in the separator, without appearance of the web at a surface of the separator.

Other manufacturing methods that may be used are disclosed in EP-A 3272908, EP-A 3660188 and EP-A 3312306.

### Dope Solution

The dope solution preferably comprises a polymer as described above, inorganic particles as described above and a solvent.

The solvent of the dope solution is preferably an organic solvent wherein the polymer can be dissolved. Moreover, the organic solvent is preferably miscible in water.

The solvent is preferably selected from N-methyl-pyrrolidone (NMP); N-ethyl-pyrrolidone (NEP); N-butyl-pyrrolidone (NBP); N,N-dimethyl-formamide (DMF); formamide; dimethylsulfoxide (DMSO); N,N-dimethyl-acetamide (DMAC); acetonitrile; and mixtures thereof.

A highly preferred solvent, for health and safety reasons, is N-butyl-pyrrolidone (NBP).

The dope solution may further comprise other ingredients to optimize the properties of the obtained porous polymer layers.

The dope solution preferably comprises an additive to optimize the pore size at the surface and inside of the porous layer. Such additives may be organic or inorganic compounds, or a combination thereof.

Organic compounds which may influence the pore formation in the porous layers include polyethylene glycol, polyethylene oxide, polypropylene glycol, ethylene glycol, tripropylene glycol, glycerol, polyhydric alcohols, dibutyl phthalate (DBP), diethyl phthalate (DEP), diundecyl phthalate (DUP), isononanoic acid or neo decanoic acid, polyvinylpyrrolidone, polyvinyl-alcohol, polyvinylacetate, polyethyleneimine, polyacrylic acid, methylcellulose and dextran.

Preferred organic compounds which may influence the pore formation in the porous layers are selected from polyethylene glycol, polyethylene oxide and polyvinylpyrrolidone.

A preferred polyethylene glycol has a molecular weight from 10 000 to 50 000, a preferred polyethylene oxide has a molecular weight from 50 000 to 300 000 and a preferred polyvinylpyrrolidone has a molecular weight of from 30 000 to 1 000 000.

A particularly preferred organic compound which may influence the pore formation in the porous layers is glycerol.

The amount of compounds which may influence the pore formation is preferably from 0.1 and 15 wt %, more preferably from 0.25 and 10 wt %, most preferably from 0.5 to 2.5 wt %, all relative to the total weight of the dope solution.

Inorganic compounds which may influence the pore formation include calcium chloride, magnesium chloride, lithium chloride and barium sulfate.

A combination of two or more additives that influence the pore formation may be used.

The dope solutions provided on either side of the porous support may be the same or different.

### Applying the Dope Solution

The dope solution may be applied on the surface of a substrate, preferably a porous support, by any coating or casting technique.

A preferred coating technique is extrusion coating.

In a highly preferred embodiment, the dope solution is applied on at least one side of a porous support by a slot die coating technique.

A slot coating dies is capable of holding the dope solution at a predetermined temperature, distributing the dope solution uniformly over the support, and adjusting the coating thickness of the applied dope solution.

The viscosity of the dope solutions measured at a shear rate of 100 s⁻¹ and a temperature of 20° C. is preferably at least 7.5 Pa·s, more preferably at least 15 Pa·s, most preferably at least 30 Pa·s.

The dope solutions are preferably shear-thinning. The ratio of the viscosity at a shear rate of 1 s⁻¹ to the viscosity at a shear rate of 100 s⁻¹ is preferably at least 2, more preferably at least 2.5, most preferably at least 5.

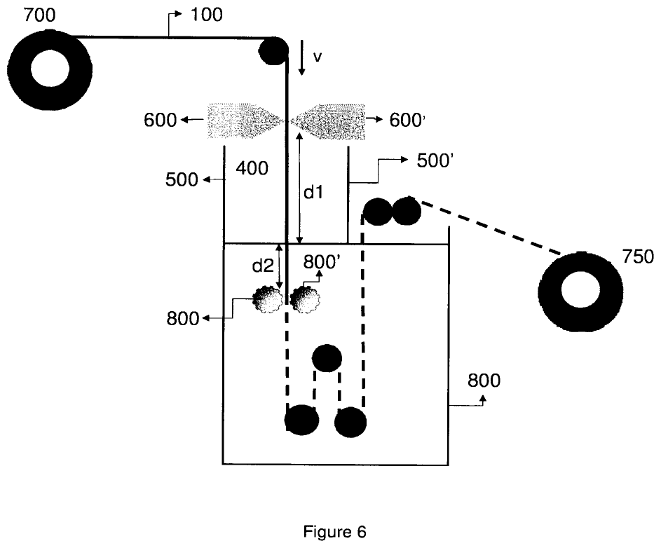

In a preferred manufacturing method (see FIG. 6) two slot coating dies (600 and 600′) are located on either side of a porous support (100). The porous support is preferably a continuous web, which is transported downwards between the slot coating dies (600, 600′).

Immediately after the application of the dope solution(s) on the porous support, the porous support becomes impregnated with the dope solution(s).

Preferably, the porous support becomes fully impregnated with the applied dope solution(s).

### Phase Inversion Step

After the application of the dope solution onto the porous support, the applied dope solution is subjected to phase inversion, also referred to as phase separation. In the phase inversion step, the applied dope solution is transformed into a porous layer.

Any phase inversion mechanism may be used to prepare the porous layer from the applied dope solution.

The phase inversion step preferably includes a so-called Liquid Induced Phase Separation (LIPS) step, a Vapour Induced Phase Separation (VIPS) step or a combination of a VIPS and a LIPS step. The phase inversion step preferably includes both a VIPS and a LIPS step.

Both LIPS and VIPS are non-solvent induced phase inversion processes.

In a LIPS step the porous support provided with the dope solution is contacted with a non-solvent that is miscible with the solvent of the dope solution.

Typically, this is carried out by immersing the porous support provided with the dope solution(s) into a non-solvent bath, also referred to as coagulation bath.

The non-solvent is preferably water; mixtures of water and an aprotic solvent selected from the group consisting of N-methylpyrrolidone (NMP), dimethylformamide (DMF), dimethylsulfoxide (DMSO) and dimethyl-acetamide (DMAC); water solutions of water-soluble polymers such as PVP or PVA; or mixtures of water and alcohols, such as ethanol, propanol or isopropanol.

The non-solvent is most preferably water.

The temperature of the coagulation bath is preferably between 2° and 90° C., more preferably between 40 and 70° C. The residence time of the separator in the coagulation bath is preferably from 1 minute to 1 hour, more preferably from 5 to 30 minutes.

The transfer of solvent from the coated polymer layer towards the non-solvent bath and of non-solvent into the polymer layer leads to phase inversion and the formation of a three-dimensional porous polymer network. The impregnation of the applied dope solution into the porous support results in a sufficient adhesion of the obtained hydrophilic layers onto the porous support.

In a preferred embodiment, the porous support (100) provided on one or both sides with a dope solution is transported downwards, in a substantially vertical position, towards a coagulation bath (800) (see FIG. 6).

In a VIPS step, the porous support coated with the dope solutions is exposed to non-solvent vapour, preferably humid air.

Preferably, the phase inversion step included both a VIPS and a LIPS step. Preferably the VIPS step is carried out before the LIPS step.

In the preferred embodiment schematically shown in FIG. 6, the VIPS step is carried out in an area 400, between the slot coating dies (600, 600′) and the surface of the non-solvent in the coagulation bath (800), which may be shielded from the environment with for example thermal isolated metal plates (500, 500′).

In the preferred case wherein the coagulation bath comprises water, the VIPS area (400) is filled with humid air.

The extent and rate of water transfer in the VIPS step can be controlled by adjusting the velocity of the air, the relative humidity and temperature of the air, as well as the exposure time.

The exposure time may be adjusted by changing the distance d1 between the slot coating dies (600, 600′) and the surface of the non-solvent in the coagulation bath (800) and/or the speed (v) with which the elongated web (100) is transported from the slot coating dies towards the coagulation bath.

The relative humidity in the VIPS area (400) may be adjusted by the temperature of the coagulation bath and the shielding of the VIPS area from the environment and from the coagulation bath.

The VIPS step carried out on one side of the separator and on the other side of the separator, resulting in the second porous polymer layer, may be identical from each other, as disclosed in EP-A 3652362.

A high RH and/or a high air speed in a VIPS area typically result in larger maximum pore diameters.

After the phase inversion step, preferably the LIPS step in the coagulation bath, a washing step may be carried out.

After the phase inversion step, or the optional washing step, a drying step may be carried out.

### Providing the Channels

The channels may be provided in the porous layer by any technique. However, the provision of the channels may not substantially change the properties of the separator properties such as gas separation, physical strength and conductivity.

The channels may for example be provided by an engraving technique such as laser engraving. For example a CO₂ laser may be used to engrave the channels into the separator.

A preferred technique that may be used for providing the channels is selected from the group consisting of knurling, embossing and rotogravure.

Knurling is a manufacturing process whereby a pattern of straight, angled or crossed lines is rolled into a material.

Embossing is a stamping process for producing a pattern into a material. A negative image of the pattern to be formed into the material is pressed into the material.

In rotogravure, a negative image of the pattern to be formed is engraved into a printing cylinder. The pattern in the porous layer is formed by pressing the porous layer against the printing cylinder.

In case of porous separators for alkaline water electrolysis, the provision of the channels may not substantially change the properties of the porous layer, such as its porosity or the diameter of the pores. Therefore, the channels are preferably provided during the phase inversion step, preferably during the LIPS step. The channels are particularly preferred provided in an early stage of the phase inversion step.

When the channels would be provided into a separator at the end of its preparation method by some kind of impression technique, the separator properties, for example the porosity, might become inhomogeneous.

For porous separators for alkaline water electrolysis, the channels are preferably provided during the phase transition step, more preferably during the LIPS step.

The porous layer needs a sufficient strength before providing the channels into the porous layer. For that reason, the LIPS is preferably on-going when the channels are introduced into the porous layer. On the other hand, when LIPS is completed the provision of the channels may become more difficult.

In the preferred method of preparing a separator with channels provided on both sides of the separator is schematically shown in FIG. 6. The channels are provided during the LIPS step by rotogravure rollers 800 and 800′. For the preparation of a separator with channels only on one side the rotogravure roller 800 may be used to provide the channels while the roller 800′ is then preferably replaced by a backing-roller.

The distance d2 between the entry of the separator into the coagulation bath (start of the LIPS step) and the provision of channels into the porous layer may be optimized to realize optimal channels. When the distance d2 is increased (at constant transportation speed v of the separator), the LIPS process is more advanced when the channels are provided into the porous layer. When the LIPS process is too advanced, the porous layer may become too solid to obtain optimal channels. When the distance d2 is too short the solidification of the porous layer may be not enough to obtain the channels.

The transportation speed v may also be optimized for obtaining optimal channels.

### Packaging

It has been observed that the water content of a manufactured separator may influence its mechanical properties. Therefore, a preferred packaging ensures that the water content remains substantially constant, even when the packaged membranes are stored for months at varying temperatures and/or relative humidities.

Preferably at least 25 volume percent, more preferably at least 40 volume percent, most preferably at least 50 volume % of the pores of the separator are filled with water. In a particularly preferred embodiment, at least 75 volume % of the pores are filled with water.

The volume % of the pores that are filled with water (Vol % P) is determined by the method described below.

The separator is typically cut in sheets of varying dimensions and a certain amount of these sheets are then packaged. An interleave may be used to separate the sheets within the package.

The water vapour transmission rate (WVTR) of packaging material gives an indication of the diffusion of water vapour in and out the packaging.

The WVTR of the packaging for the separators according to the present invention is preferably less than 5 g/m²/24 hours, more preferably less than 2.5 g/m²/24 hours, most preferably less than 1 g/m²/24 hours, particularly preferred less than 0.5 g/m²/24 hours. However, the WVTR of the packaging may be less than 0.1 g/m²/24 hours or even less than 0.01 g/m²/24 hours.

Any packaging material may be used having the WVTR values described above.

A typical packaging material comprises a barrier laminate prepared from different foils/materials, such as for example aluminium, polyethylene (PE), polyethylene terephthalate (PET), oriented polypropylene (OPP) or non-woven materials. Such a barrier laminate is typically provided on a core, such as cardboard.

A preferred barrier laminate is for example a PET/PE laminate, for example a PET/PE laminate of a 12 μm (+/− 10%) PET foil and a 75 μm (+/− 15%) PE foil. This barrier laminate is then preferably provided on a cardboard, for example a 76 mm thick cardboard.

### Electrolytic Cell

The separator for alkaline water electrolysis according to the present invention may be a used in an alkaline water electrolyser.

An electrolysis cell typically consists of two electrodes, an anode and a cathode, separated by a separator. An electrolyte is present between both electrodes.

When electrical current is supplied to the electrolysis cell, hydroxyl ions of the electrolyte are oxidized into oxygen at the anode and water is reduced to hydrogen at the cathode. The hydroxyl ions formed at the cathode migrate through the separator to the anode. The separator prevents mixing of the hydrogen and oxygen gases formed during electrolysis.

An electrolyte solution is typically an alkaline solution. Preferred electrolyte solutions are aqueous solutions of electrolytes selected from sodium hydroxide or potassium hydroxide. Potassium hydroxide electrolytes are often preferred due to their higher specific conductivity. The concentration of the electrolyte in the electrolyte solution is preferably from 20 to 40 wt %, relative to the total weight of the electrolyte solution.

The temperature of the electrolyte is preferably from 50° C. to 120° C., more preferably from 75° C. to 100° C., most preferably from 80° to 90° C. However, a higher temperature, for example at least 100° C., more preferably from 125° C. to 165° C. may result in a more efficient electrolysis.

An electrode typically include a substrate provided with a so-called catalyst layer. The catalyst layer may be different for the anode, where oxygen is formed, and the cathode, where hydrogen is formed.

Typical substrates are made from electrically conductive materials selected from the group consisting of nickel, iron, soft steels, stainless steels, vanadium, molybdenum, copper, silver, manganese, platinum group elements, graphite, and chromium. The substrates may be made from an electrically conductive alloy of two or more metals or a mixture of two or more electrically conductive materials. A preferred material is nickel or nickel-based alloys. Nickel has a good stability in strong alkaline solutions, has a good conductivity and is relatively cheap.

A catalyst layer preferably includes nickel, cobalt, iron, and platinum group elements. The catalyst layer may include these elements as elemental metals, compounds (e.g. oxides), composite oxides or alloys made of multiple metal elements, or mixtures thereof. Preferred catalyst layers include plated nickel, plated alloys of nickel and cobalt or nickel and iron, complex oxides including nickel and cobalt such as LaNiO₃, LaCoO₃, and NiCO₂O₄, compounds of platinum group elements such as iridium oxide, or carbon materials such as graphene.

A particularly preferred catalyst layer comprises Raney Nickel. The Raney nickel structure is formed by selectively leaching aluminium or zinc from a Ni—Al or Ni—Zn alloy. Lattice vacancies formed during leaching result in a large surface area and a high density of lattice defects, which are active sites for the electrocatalytic reaction to take place.

Preferred porous electrodes and methods to prepare them are disclosed in for example EP-A 3575442, paragraphs 23 to 84.

The pore size of porous electrodes may have an influence on the electrolysis efficiency. For example, in EP-A 3575442 it is disclosed that preferred pore sizes of the porous electrodes are from 10 nm up to 200 nm.

The catalyst layer may also include organic substances such as polymers to improve the durability and the adhesion towards the substrate.

The separator according to the present invention is preferably used in a so-called zero gap electrolytic cell. In such a zero gap electrolytic cell, the electrodes are placed directly in contact with the separator thereby reducing the space between both electrodes. Mesh-type or porous electrodes are used to enable the separator to be filled with electrolyte and for efficient removal of the oxygen and hydrogen gases formed. It has been observed such zero gap electrolytic cells operate at higher current densities.

A typical alkaline water electrolyser include several electrolytic cells, also referred to as a stack of electrolytic cells.

Regarding the cell configuration, two types of electrolysers are typically used.

A unipolar (or “tank-type”) electrolyser consists of alternate positive and negative electrodes held apart by a separator. Positive electrodes are all coupled together in parallel, as are the negative electrodes, and the whole assembly is immersed in a single electrolyte bath (“tank”) to form a unit cell. A plant-scale electrolyser is then built up by connecting these units electrically in series. The total voltage applied to the whole electrolysis cell is the same as that applied to the individual unit cells.

On the other hand, in a bipolar electrolyser a metal sheet (or “bipole”) connects electrically adjacent cells in series. The electrocatalyst for the negative electrode is coated on one face of the bipole and that for the positive electrode of the adjacent cell is coated on the reverse face. In this case, the total cell voltage is the sum of the individual unit cell voltages. Therefore, a series-connected stack of such cells forms a module that operates at a higher voltage and lower current than the tank-type (unipolar) design. To meet the requirements of a large electrolysis plant, these modules are connected in parallel so as to increase the current.

1-15. (canceled)

16. A separator for water electrolysis comprising on at least one side thereof:
a surface area Sₘₐₓ,
a surface area S_{c} for contacting a surface of an electrode, and
a channel having a cross section Φ_{c} for evacuating gas bubbles, characterized in that:
a ratio S_{c}/Sₘₐₓ is from 0.025 to 0.50 and
the cross section Φ_{c} is large enough for evacuating gas bubbles having a diameter from 5 to 50 μm.

17. The separator of claim 16, wherein the separator comprises a porous layer provided on a porous support and wherein the channels are provided in the porous layer.

18. The separator of claim 16, wherein the separator comprises a first and a second porous layer provided respectively on one and the other side of the porous support, wherein the channels are provided in the first and/or the second porous layer.

19. The separator of claim 18, wherein the first and the second porous layers are the same.

20. The separator of claim 17, wherein a thickness t2 of the separator is from 50 to 750 μm.

21. The separator of claim 17, wherein a thickness t1 of the porous support is from 20 to 350 μm.

22. The separator of claim 17 having a gas permeability from 2 to 5.8 L/min.cm² measured at 5 bar.

23. The separator of claim 17 having an ionic resistance of less than 0.1 ohm.cm² at 80° C. in a 30 wt % aqueous KOH solution.

24. The separator of claim 17, wherein the porous layer comprises a polymer and inorganic particles.

25. The separator of claim 24, wherein the polymer is at least one selected from the group consisting of polysulfone, polyethersulfone, polyphenylene sulfide, polyether ether ketone, and polyphenylsulfone.

26. The separator of claim 25, wherein the inorganic particles are selected from the group consisting of zirconium oxides, zirconium hydroxides, magnesium oxides, magnesium hydroxides, titanium oxides, titanium hydroxides and bariumsulfate.

27. The separator of claim 24, wherein the inorganic particles are selected from the group consisting of zirconium oxides, zirconium hydroxides, magnesium oxides, magnesium hydroxides, titanium oxides, titanium hydroxides and bariumsulfate.

28. A method of manufacturing the separator of claim 17, the method comprising the steps of:
applying a dope solution on a side of a porous support;
performing phase inversion on the applied dope solution thereby forming a separator comprising a porous layer on the support; and
providing channels into the porous layer during the phase inversion step.

29. The method of claim 28, wherein the channels are provided in the porous layer during the phase inversion step by knurling, embossing, or rotogravure.

30. A zero gap electrolytic cell for water electrolysis comprising a separator as defined in claim 16.

31. Use of a separator as defined in claim 16 to produce green hydrogen, green ammonia, and green steel.

32. A method of manufacturing the separator of claim 25, the method comprising the steps of:
applying a dope solution on a side of a porous support;
performing phase inversion on the applied dope solution thereby forming a separator comprising a porous layer on the support; and
providing channels into the porous layer during the phase inversion step.

33. The method of claim 32, wherein the channels are provided in the porous layer during the phase inversion step by knurling, embossing, or rotogravure.

34. A zero gap electrolytic cell for water electrolysis comprising a separator as defined in claim 25.

35. Use of a separator as defined in claim 25 to produce green hydrogen, green ammonia, and green steel.
